(19) United States
(12) Patent Application Publication
(10) Pub. No.: US 2020/0183206 A1
(43) Pub. Date: Jun. 11, 2020

(54) DISPLAY DEVICE AND MANUFACTURING METHOD THEREOF

(71) Applicant: Wuhan China Star Optoelectronics Semiconductor Display Technology Co. Ltd, Wuhan Hubei (CN)

(72) Inventor: Zhao LI, Wuhan (CN)

(73) Assignee: Wuhan China Star Optoelectronics Semiconductor Display Technology Co., ltd, Wuhan Hubei (CN)

(21) Appl. No.: 16/462,957

(22) PCT Filed: Feb. 21, 2019
(86) PCT No.: PCT/CN2019/075724

§ 371 Date: May 22, 2019

(30) Foreign Application Priority Data
Nov. 26, 2018 (CN) 201811417981.4

(51) Int. Cl. G02F 1/1339; G02F 1/1343; G06F 1/16; G02B 1/14

(52) U.S. Cl. CPC G02F 1/1339; G02F 1/13439; G02F 2202/28; G02B 1/14; G06F 1/1609

(57) ABSTRACT

A display device and a manufacturing method thereof of the claimed disclosure are provided. The display device comprises a first display panel and a second display panel. An adhesive layer is adhered to the first cathode layer and the second cathode layer to make the display device having double-sided display function provided by the present application can without a package structure, thereby reducing the thickness of the display device, and realizing a thin display device having a double-sided display function.

### FIELD OF DISCLOSURE

The present disclosure relates to the field of display, and in particular to a display device having a double-sided display function and a manufacturing method thereof.

### BACKGROUND OF DISCLOSURE

In the prior art, a display device having a double-sided display function generally needs to arrange two sets of displays, which are two independent light-emitting diode displays, liquid crystal displays or organic light-emitting diode displays with back to back setting. Each of the independent displays needs to be provided with a package structure on the outside of cathode of the displays. The back-to-back setting of two independent displays results in a larger thickness of the display device with double-sided display function and does not meet the current consumer demand for thinner display device. Therefore, how to provide a display device and a manufacturing method thereof having thin thickness and double-sided display function are currently urgent problems to be solved.

### Technical Problem

The present disclosure provides a display device and a manufacturing method thereof for providing a display device and a manufacturing method thereof having thin thickness and double-sided display function.

### Technical Solution

The present disclosure provides a display device, and the display device comprises:

A first display panel, wherein the first display panel comprises a first array substrate, and wherein a first anode layer, a first hole transport layer, a first light emitting layer, a first electron transport layer, and a first cathode layer are disposed on the first array substrate in turn, and a light emitting surface of the first display panel is located at the first array substrate;

A second display panel, wherein the second display panel comprises a second array substrate, and wherein a second anode layer, a second hole transport layer, a second light emitting layer, a second electron transport layer, and a second cathode layer are disposed on the second array substrate in turn, and a light emitting surface of the second display panel is located at the second array substrate; and

An adhesive layer disposed between the first display panel and the second display panel, wherein the adhesive layer is adhered to the first cathode layer and the second cathode layer.

In the display device of the present disclosure, the first anode layer and the second anode layer are made of transparent indium tin oxide.

In the display device of the present disclosure, the first anode layer and the second anode layer have a thickness of 20 nm to 200 nm.

In the display device of the present disclosure, the first cathode layer is a first light-reflecting layer to reflect light emitted from the first light emitting layer, and the second cathode layer is a second light-reflecting layer to reflect light emitted from the second light emitting layer.

In the display device of the present disclosure, the first cathode layer and the second cathode layer are made of metal material, and the metal material is silver or aluminum.

In the display device of the present disclosure, the first cathode layer and the second cathode layer have a thickness of 20 nm to 200 nm.

In the display device of the present disclosure, the adhesive layer is made of a photocurable material.

In the display device of the present disclosure, the adhesive layer is made of acryl resin, and a thickness of the adhesive layer is from 1 micron to 20 micrometers.

The present disclosure provides a manufacturing method of a display device, comprising the following steps of:

Providing a first array substrate;

Forming a first anode layer, a first hole transport layer, a first light emitting layer, a first electron transport layer, and a first cathode layer on the first array substrate in turn to form a first display panel;

Providing a second array substrate;

Forming a second anode layer, a second hole transport layer, a second light emitting layer, a second electron transport layer, and a second cathode layer on the second array substrate in turn to form a second display panel;

Forming an adhesive layer on the first cathode layer of the first display panel; and

Adhering the second cathode layer of the second display panel to the adhesive layer.

In the manufacturing method of the display device of the present disclosure, the steps of forming the first anode layer, the first hole transport layer, the first light emitting layer, the first electron transport layer, and the first cathode layer on the first array substrate in turn to form the first display panel, and forming the second anode layer, the second hole transport layer, the second light emitting layer, the second electron transport layer, and the second cathode layer on the second array substrate in turn to form the second display panel are proceeded in a vacuum environment.

In the manufacturing method of the display device of the present disclosure, the adhesive layer is formed on the first cathode layer of the first display panel by inkjet printing.

In the manufacturing method of the display device of the present disclosure, the steps of adhering the second cathode layer of the second display panel to the adhesive layer further comprises:

curing the adhesive layer by ultraviolet light.

In the manufacturing method of the display device of the present disclosure, the first anode layer and the second anode layer are made of transparent indium tin oxide.

In the manufacturing method of the display device of the present disclosure, the first anode layer and the second anode layer have a thickness of nm to 200 nm.

In the manufacturing method of the display device of the present disclosure, the first cathode layer and the second cathode layer are made of metal material, and the metal material is silver or aluminum.

In the manufacturing method of the display device of the present disclosure, the first cathode layer and the second cathode layer have a thickness of 20 nm to 200 nm.

In the manufacturing method of the display device of the present disclosure, the adhesive layer is made of a photocurable material.

In the manufacturing method of the display device of the present disclosure, the adhesive layer is made of acryl resin, and a thickness of the adhesive layer is from 1 micron to 20 micrometers.

### Beneficial Effect

The beneficial effects of the present disclosure are described as follows. In the display device and the manufacturing method thereof provided by the present disclosure, the display device comprises a first display panel and a second display panel. The first display panel comprises a first array substrate, and wherein a first anode layer, a first hole transport layer, a first light emitting layer, a first electron transport layer, and a first cathode layer are disposed on the first array substrate in turn, and a light emitting surface of the first display panel is located at the first array substrate. The second display panel comprises a second array substrate, and wherein a second anode layer, a second hole transport layer, a second light emitting layer, a second electron transport layer, and a second cathode layer are disposed on the second array substrate in turn, and a light emitting surface of the second display panel is located at the second array substrate. The adhesive layer is adhered to the first cathode layer and the second cathode layer. Therefore, the display device with double-sided display function provided by the present disclosure does not need a package structure, thereby reducing the thickness of the display device, and realizing a thin display device having a double-sided display function.

### DESCRIPTION OF DRAWINGS

In order to more clearly illustrate the technical solutions of the embodiments or the prior art, the drawings used in the embodiments or the prior art description will be briefly described below. Obviously, the drawings in the following description are merely for the present disclosure. Some embodiments of the present disclosure can also be obtained by other drawings according to these drawings without any creative work for those skilled in the art.

FIG. 1 is a schematic flow chart of an embodiment of a method for manufacturing a liquid crystal display provided by the present disclosure;

FIG. 2 is a schematic structural view of a first embodiment of a mother board of an array substrate in a manufacturing method of a liquid crystal display provided by the present disclosure;

FIG. 3 is a schematic structural view of a first embodiment of a composite substrate in a manufacturing method of a liquid crystal display provided by the present disclosure;

FIG. 4 is a schematic structural view of a second embodiment of a mother board of an array substrate in a manufacturing method of a liquid crystal display provided by the present disclosure; and

FIG. 5 is a schematic structural view of a second embodiment of a composite substrate in a manufacturing method of a liquid crystal display provided by the present disclosure.

### DETAILED DESCRIPTION OF PREFERRED EMBODIMENTS

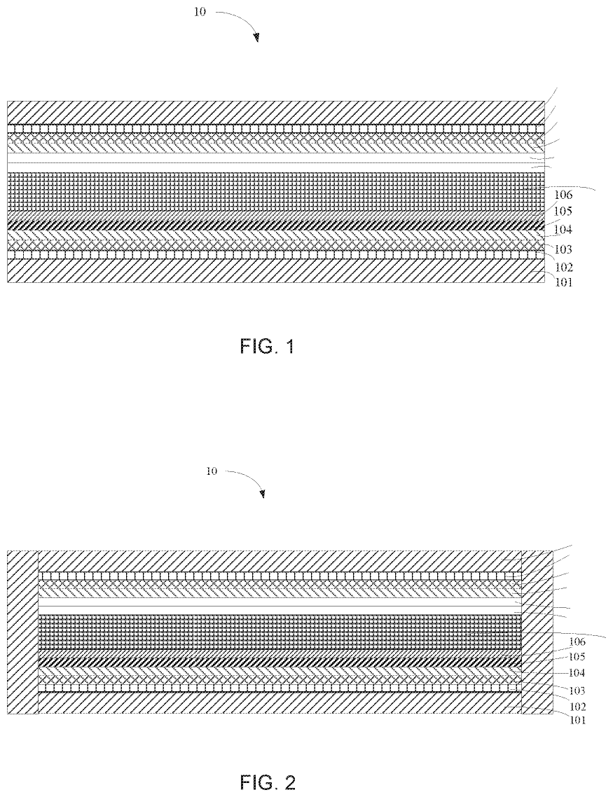

Please refer to FIG. 1, FIG. 1 is a first schematic structural view of a display device of the present disclosure. The present disclosure provides a display device 10. The display device 10 includes a first display panel 100, a second display panel 200 and an adhesive layer 300. The adhesive layer 300 is disposed between the first display panel 100 and the second display panel 200.

The first display panel 100 comprises a first array substrate 101, a first anode layer 102, a first hole transport layer 103, a first light emitting layer 104, a first electron transport layer 105, and a first cathode layer 106. The first anode layer 102, the first hole transport layer 103, the first light emitting layer 104, the first electron transport layer 105, and the first cathode layer 106 are disposed on the first array substrate 101 in turn.

A portion of the light emitted by the first light emitting layer 104 is directly emitted by the first array substrate 101 through the first display panel 100. The first cathode layer 106 is a first light reflecting layer to reflect light emitted by the first light emitting layer 104. Another portion of the light emitted by the first light emitting layer 104 is reflected by the first cathode layer 106 and then emitted by the first array substrate 101 through the first display panel 100.

In order to ensure that the first anode layer 102 has good light transmittance and conductivity, the first anode layer 102 may be made of a transparent material. The transparent material can be transparent indium tin oxide. The thickness of the first anode layer 102 is from 20 nm to 200 nm. In some embodiment, the thickness of the first anode layer 102 is 50 nm, 70 nm, 100 nm, 140 nm or 160 nm.

The first cathode layer 106 is a first light-reflecting layer and is made of a conductive reflective material. The first cathode layer 106 may be silver or copper. In order to ensure that the first cathode layer 106 has good light reflectivity and electrical conductivity, the first cathode layer 106 has a thickness of from 20 nm to 200 nm. In some embodiments, the thickness of the first cathode layer 106 is 50 nm, 80 nm, 100 nm, 120 nm or 180 nm.

The second display panel 200 comprises a second array substrate 201, a second anode layer 202, a second hole transport layer 203, a second light emitting layer 204, a second electron transport layer 205, and a second cathode layer 206. The second anode layer 202, the second hole transport layer 203, the second light emitting layer 204, the second electron transport layer 205, and the second cathode layer 206 are disposed on the second array substrate 201 in turn.

A portion of the light emitted by the second light emitting layer 204 is directly emitted by the second first array substrate 201 through the second display panel 200. The second cathode layer 206 is a second light reflecting layer to reflect light emitted by the second light emitting layer 204. Another portion of the light emitted by the second light emitting layer 204 is reflected by the second cathode layer 206 and then emitted by the second array substrate 201 to the second display panel 200.

In order to ensure that the second anode layer 202 has good light transmittance and conductivity, the second anode layer 202 may be made of a transparent material. The transparent material can be transparent indium tin oxide. The thickness of the second anode layer 202 is from 20 nm to 200 nm. In some embodiment, the thickness of the second anode layer 202 is 50 nm, 70 nm, 100 nm, 140 nm or 160 nm.

The second cathode layer 206 is a second light-reflecting layer and is made of a conductive reflective material. The second cathode layer 206 may be silver or copper. In order to ensure that the second cathode layer 206 has good light reflectivity and electrical conductivity, the second cathode layer 206 has a thickness of from 20 nm to 200 nm. In some embodiments, the thickness of the second cathode layer 206 is 50 nm, 80 nm, 100 nm, 120 nm or 180 nm.

The adhesive layer 300 is adhered to the first cathode layer 106 and the second cathode layer 206. In one embodiment, the adhesive layer 300 is a photocurable material. The adhesive layer 300 may be an ultraviolet curing material. The adhesive layer 300 may be made of an acrylic resin. In order to ensure that the adhesive layer 300 has a high adhesive force and has a small thickness, the adhesive layer 300 has a thickness of 1 nm to 20 nm. In some embodiments, the thickness of the adhesive layer 300 is 2 nm, 5 nm, 8 nm, 10 nm, or 18 nm.

Please refer to FIG. 2, FIG. 2 is a second schematic structural view of a display device of the present disclosure. The display device 10 further includes a support structure. The support structure surrounds the first display panel 100, the second display panel 200, and the adhesive layer 300. The support structure may include a plastic frame surrounding the first display panel 100, the second display panel 200, and the adhesive layer 300, and an outer frame of the display, and thus to protect the display device 10 from water and shock.

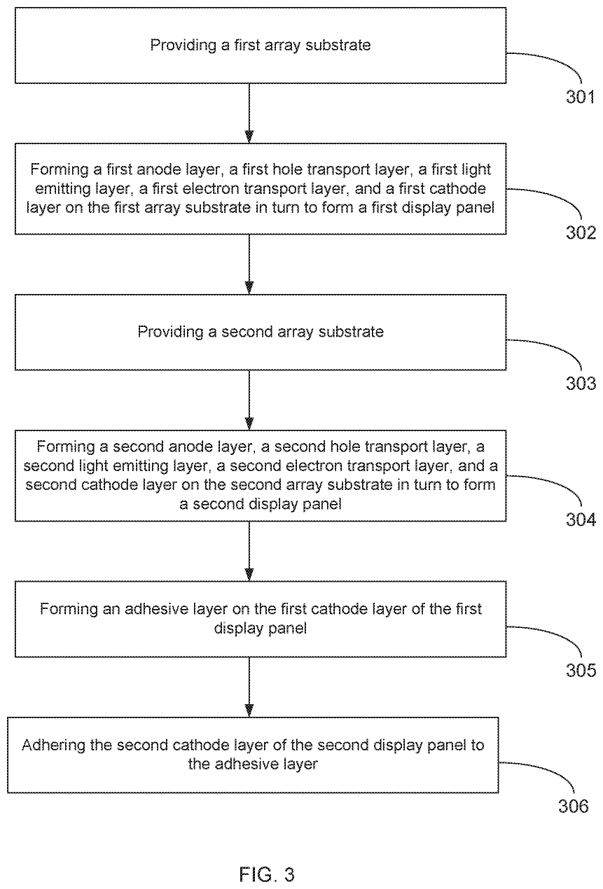

Please refer to FIG. 3. FIG. 3 is a schematic flow chart of an embodiment of a manufacturing method provided by the present disclosure. The present disclosure further provides a manufacturing method of a display device. The method includes:

301: Providing a first array substrate 101.

The first array substrate 101 includes a substrate and a thin film transistor array disposed on the substrate.

302: Forming a first anode layer 102, a first hole transport layer 103, a first light emitting layer 104, a first electron transport layer 105, and a first cathode layer 106 on the first array substrate 101 in turn to form a first display panel 100.

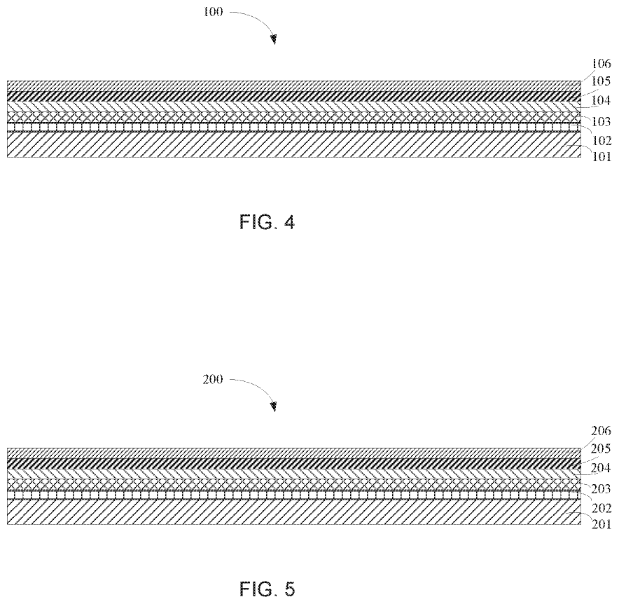

Please refer to FIG. 4, FIG. 4 is a schematic structural view of the first display panel of the display device provided by an embodiment of the present disclosure. A portion of the light emitted by the first light emitting layer 104 is directly emitted by the first array substrate 101 from the first display panel 100. The first cathode layer 106 is a first light reflecting layer to reflect light emitted by the first light emitting layer 104. Another portion of the light emitted by the first light emitting layer 104 is reflected by the first cathode layer 106 and then emitted by the first array substrate 101 to the first display panel 100.

In order to ensure that the first anode layer 102 has good light transmittance and conductivity, the first anode layer 102 may be made of a transparent material. The transparent material can be transparent indium tin oxide. The thickness of the first anode layer 102 is from 20 nm to 200 nm. In some embodiment, the thickness of the first anode layer 102 is 50 nm, 70 nm, 100 nm, 140 nm or 160 nm.

The first cathode layer 106 is a first light-reflecting layer and is made of a conductive reflective material. The first cathode layer 106 may be silver or copper. In order to ensure that the first cathode layer 106 has good light reflectivity and electrical conductivity, the first cathode layer 106 has a thickness of from 20 nm to 200 nm. In some embodiments, the thickness of the first cathode layer 106 is 50 nm, 80 nm, 100 nm, 120 nm or 180 nm.

303: Providing a second array substrate 201.

The second array substrate 201 includes a substrate and a thin film transistor array disposed on the substrate.

304: Forming a second anode layer 202, a second hole transport layer 203, a second light emitting layer 204, a second electron transport layer 205, and a second cathode layer 206 on the second array substrate 201 in turn to form a second display panel 200.

Please refer to FIG. 5. FIG. 5 is a schematic structural view of the second display panel of the display device provided by an embodiment of the present disclosure. A portion of the light emitted by the second light emitting layer 204 is directly emitted by the second array substrate 201 from the second display panel 200. The second cathode layer 206 is a second light reflecting layer to reflect light emitted by the second light emitting layer 204. Another portion of the light emitted by the second light emitting layer 204 is reflected by the second cathode layer 206 and then emitted by the second array substrate 201 to the second display panel 200.

In order to ensure that the second anode layer 202 has good light transmittance and conductivity, the second anode layer 202 may be made of a transparent material. The transparent material can be transparent indium tin oxide. The thickness of the second anode layer 202 is from 20 nm to 200 nm. In some embodiment, the thickness of the second anode layer 202 is 50 nm, 70 nm, 100 nm, 140 nm or 160 nm.

The second cathode layer 206 is a second light-reflecting layer and is made of a conductive reflective material. The second cathode layer 206 may be silver or copper. In order to ensure that the second cathode layer 206 has good light reflectivity and electrical conductivity, the second cathode layer 206 has a thickness of from 20 nm to 200 nm. In some embodiments, the thickness of the second cathode layer 206 is 50 nm, 80 nm, 100 nm, 120 nm or 180 nm.

In one embodiment, the steps 301, 302, 303, and 304 may be performed in the order of 301, 302, 303, and 304, and may also be performed in the order of 303, 304, 301, and 302.

The step of forming the first anode layer 102, the first hole transport layer 103, the first light emitting layer 104, the first electron transport layer 105, and the first cathode layer 106 on the first array substrate 101 in turn, and the step of forming the second anode layer 202, the second hole transport layer 203, the second light emitting layer 204, the second electron transport layer 205, and the second cathode layer 206 on the second array substrate 201 in turn are proceeded in a vacuum environment.

305: Forming an adhesive layer 300 on the first cathode layer 106 of the first display panel 100.

In one embodiment, an adhesive layer 300 is formed on the first cathode layer 106 of the first display panel 100 by inkjet printing.

In one embodiment, the adhesive layer 300 is made of a photocurable material. The adhesive layer 300 can be made of an ultraviolet curing material. The adhesive layer 300 is made of acryl resin. In order to ensure that the adhesive layer 300 has a high adhesive force and has a small thickness, a thickness of the adhesive layer 300 is from 1 mm to 20 mm. In some embodiments, the thickness of the adhesive layer 300 is selected from one of 2 mm, 5 mm, 8 mm, 10 mm and 18 mm.

306: Adhering the second cathode layer 206 of the second display panel 200 to the adhesive layer 300 (as shown in FIG. 1).

After the adhering is completed, the adhesive layer 300 is irradiated with an ultraviolet light to cure the adhesive layer 300 to fixedly connect the first display panel 100 and the second display panel 200. During the curing process, due to the reflection of the light by the first cathode layer 106 and the second cathode layer 206, the ultraviolet light may be irradiated from the side of the adhesive layer 300 to cure the adhesive layer 300.

In other embodiments, the adhesive layer 300 may also be a thermosetting material. The adhesive layer 300 is cured by heating.

The step of forming an adhesive layer 300 on the first cathode layer 106 of the first display panel 100, and the step of forming the adhesive layer 300 on the second cathode layer 206 of the second display panel 200 are proceeded in a nitrogen atmosphere.

In the display device and the manufacturing method thereof provided by the present disclosure, the display device includes a first display panel and a second display panel. The first display panel comprises a first array substrate, wherein a first anode layer, a first hole transport layer, a first light emitting layer, a first electron transport layer, and a first cathode layer are disposed on the first array substrate in turn. The second display panel comprises a second array substrate, wherein a second anode layer, a second hole transport layer, a second light emitting layer, a second electron transport layer, and a second cathode layer are disposed on the second array substrate in turn. The adhesive layer is adhered to the first cathode layer and the second cathode layer. Therefore, the display device with double-sided display function provided by the present disclosure does not need a package structure, thereby reducing the thickness of the display device, and realizing a thin display device having a double-sided display function.

The embodiments of the present application are described in detail above, and the principles and implementations of the present application are set forth in the specific examples. The description of the above embodiments is only for helping to understand the present application. In the meantime, those skilled in the art will have various changes in the specific embodiments and application scopes according to the idea of the present application. In summary, the content of the present specification should not be construed as limiting the present application.

What is claimed is:

1. A display device, comprising:
a first display panel, wherein the first display panel comprises a first array substrate, and wherein a first anode layer, a first hole transport layer, a first light emitting layer, a first electron transport layer, and a first cathode layer are disposed on the first array substrate in turn, and a light emitting surface of the first display panel is located at the first array substrate;
a second display panel, wherein the second display panel comprises a second array substrate, and wherein a second anode layer, a second hole transport layer, a second light emitting layer, a second electron transport layer, and a second cathode layer are disposed on the second array substrate in turn, and a light emitting surface of the second display panel is located at the second array substrate; and
an adhesive layer disposed between the first display panel and the second display panel, wherein the adhesive layer is adhered to the first cathode layer and the second cathode layer.

2. The display device as claimed in claim 1, wherein the first anode layer and the second anode layer are made of transparent indium tin oxide.

3. The display device as claimed in claim 2, wherein the first anode layer and the second anode layer have a thickness of 20 nm to 200 nm.

4. The display device as claimed in claim 1, wherein the first cathode layer is a first light-reflecting layer to reflect light emitted from the first light emitting layer, and the second cathode layer is a second light-reflecting layer to reflect light emitted from the second light emitting layer.

5. The display device as claimed in claim 4, wherein the first cathode layer and the second cathode layer are made of metal material, and the metal material is silver or aluminum.

6. The display device as claimed in claim 4, wherein the first cathode layer and the second cathode layer have a thickness of 20 nm to 200 nm.

7. The display device as claimed in claim 1, wherein the adhesive layer is made of a photocurable material.

8. The display device as claimed in claim 7, wherein the adhesive layer is made of acryl resin, and a thickness of the adhesive layer is from 1 mm to 20 mm.

9. A manufacturing method of a display device, comprising the following steps of:
providing a first array substrate;
forming a first anode layer, a first hole transport layer, a first light emitting layer, a first electron transport layer, and a first cathode layer on the first array substrate in turn to form a first display panel;
providing a second array substrate;
forming a second anode layer, a second hole transport layer, a second light emitting layer, a second electron transport layer, and a second cathode layer on the second array substrate in turn to form a second display panel;
forming an adhesive layer on the first cathode layer of the first display panel; and
adhering the second cathode layer of the second display panel to the adhesive layer.

10. The manufacturing method of the display device as claimed in claim 9, wherein the steps of forming the first anode layer, the first hole transport layer, the first light emitting layer, the first electron transport layer, and the first cathode layer on the first array substrate in turn to form the first display panel, and forming the second anode layer, the second hole transport layer, the second light emitting layer, the second electron transport layer, and the second cathode layer on the second array substrate in turn to form the second display panel are proceeded in a vacuum environment.

11. The manufacturing method of the display device as claimed in claim 9, wherein the adhesive layer is formed on the first cathode layer of the first display panel by inkjet printing.

12. The manufacturing method of the display device as claimed in claim 9, wherein the steps of disposing the adhesive layer on the first cathode layer of the first display panel and adhering the second cathode layer of the second display panel to the adhesive layer are proceeded in a nitrogen atmosphere.

13. The manufacturing method of the display device as claimed in claim 9, wherein the steps of adhering the second cathode layer of the second display panel to the adhesive layer further comprises:
curing the adhesive layer by ultraviolet light.

14. The manufacturing method of the display device as claimed in claim 9, wherein the first anode layer and the second anode layer are made of transparent indium tin oxide.

15. The manufacturing method of the display device as claimed in claim 9, wherein the first anode layer and the second anode layer have a thickness of 20 nm to 200 nm.

16. The manufacturing method of the display device as claimed in claim 9, wherein the first cathode layer and the second cathode layer are made of metal material, and the metal material is silver or aluminum.

17. The manufacturing method of the display device as claimed in claim 9, wherein the first cathode layer and the second cathode layer have a thickness of 20 nm to 200 nm.

18. The manufacturing method of the display device as claimed in claim 9, wherein the adhesive layer is made of a photocurable material.

19. The manufacturing method of the display device as claimed in claim 9, wherein the adhesive layer is made of acryl resin, and a thickness of the adhesive layer is from 1 mm to 20 mm.
